(19) United States
(12) Patent Application Publication
(10) Pub. No.: US 2022/0262096 A1
(43) Pub. Date: Aug. 18, 2022

(54) IMAGE PROCESSING DEVICE AND IMAGE PROCESSING METHOD

(71) Applicant: NEC Corporation, Minato-ku, Tokyo (JP)

(72) Inventors: Taichi TANAKA, Tokyo (JP); Osamu HOSYUYAMA, Tokyo (JP)

(73) Assignee: NEC Corporation, Minato-ku, Tokyo (JP)

(21) Appl. No.: 17/627,217

(22) PCT Filed: Jul. 18, 2019
(86) PCT No.: PCT/JP2019/028265

§ 371 Date: Jan. 14, 2022

(51) Int. Cl. G06V 10/75; G06V 10/30; G06V 10/762; G01S 13/90

(52) U.S. Cl. CPC G06V 10/751; G06V 10/30; G01S 13/9021; G06V 10/7635; G06V 10/763

(57) ABSTRACT

The image processing device 10 includes intensity calculation means 11 for calculating intensity of the sample pixel, neighboring pixel selection means 12 for selecting neighboring pixels that have a similar statistical property of intensity to the sample pixel, based on the intensity of the sample pixel, phase specifying means 13 for specifying phases of the neighboring pixels, and pixel classification means 14 for classifying the neighboring pixels based on correlation of the phases of the neighboring pixels.

### TECHNICAL FIELD

The present invention relates to an image processing device and an image processing method for a synthetic aperture radar capable of easily associating a SAR image with a target.

### BACKGROUND ART

Synthetic aperture radar (SAR) technology is a technology which can obtain an image equivalent to the image by an antenna having a large aperture, when a flying object such as artificial satellite, aircraft, or the like transmits and receives a radio wave while the flying object moves. The synthetic aperture radar is utilized, for example, for analyzing an elevation or a ground surface deformation by signal-processing reflected waves from the ground surface. When SAR technology is used, the analysis device takes time-series SAR images (SAR data) obtained by a synthetic aperture radar as input, and performs time-series analysis of the input SAR images.

When SAR images are used, it is desirable to be able to easily associate a target of observation, such as the ground surface or a structure, with the corresponding point in the SAR image.

Patent literature 1 describes a method for clustering pixels of PS (Persistent Scatterer) points in a SAR image so as to easily associate a target with a location in the SAR image. In the method described in patent literature 1, the clustering is performed based on the correlation of the phases of a plurality of PS points.

Note that patent literature 2 describes a method for detecting pixels that are statistically homogeneous with a certain pixel.

In addition, non patent literature 1 describes an analysis method that utilizes a pixel called an SHP (Statistically Homogeneous Pixel), which is a pixel whose noise properties do not change between multiple time periods. As SHPs, pixels that have similarity in terms of intensity (reflection intensity) are selected.

### CITATION LIST

### Patent Literature

PTL 1: International Publication No. 2018/123748
PTL 2: International Publication No. 2010/112426

### Non Patent Literature

NPL 1: A. Ferretti et. al., “A New Algorithm for Processing Interferometric Data-Stacks: SqueeSAR”, IEEE Transactions on Geoscience and Remote Sensing, Vol. 49, No. 9, pp. 3460-3470, September 2011

### SUMMARY OF INVENTION

### Technical Problem

In the method described in patent literature 1, the number of measurement points may be small because only Persistent Scatterer (PS) points are used as measurement points. In such a case, it may be difficult to associate the observation target with the corresponding point in the SAR image. In the method described in patent literature 1, if the number of measurement points is increased, i.e., the number of pixels to be clustered is increased, and clustering is performed, there is a possibility that pixels with different properties of phase noise are mixed. Since the method described in patent literature 1 performs clustering based on phase correlation, in a situation where pixels having different properties of phase noise are mixed, there is a possibility that the cluster generated will differ from the desired cluster configuration.

It is an object of the present invention to provide an image processing device and an image processing method capable of performing a desired classification even when the number of pixels of a target of classification is increased, and thereby enabling a SAR image to be more easily associated with a target.

### Solution to Problem

An image processing device according to the present invention includes intensity calculation means for calculating intensity of the sample pixel, neighboring pixel selection means for selecting neighboring pixels that have a similar statistical property of intensity to the sample pixel, based on the intensity of the sample pixel, phase specifying means for specifying phases of the neighboring pixels, and pixel classification means for classifying the neighboring pixels based on correlation of the phases of the neighboring pixels.

An image processing method according to the present invention includes calculating intensity of the sample pixel, selecting neighboring pixels that have a similar statistical property of intensity to the sample pixel, based on the intensity of the sample pixel, specifying phases of the neighboring pixels, and classifying the neighboring pixels based on correlation of the phases of the neighboring pixels.

An image processing program according to the present invention causes a computer to execute a process of calculating intensity of the sample pixel, a process of selecting neighboring pixels that have a similar statistical property of intensity to the sample pixel, based on the intensity of the sample pixel, a process of specifying phases of the neighboring pixels, and a process of classifying the neighboring pixels based on correlation of the phases of the neighboring pixels.

### Advantageous Effects of Invention

According to the present invention, the desired classification can be performed even if the number of pixels of the target of classification is increased, and as a result, it is possible to more easily associate the SAR image with the target.

### BRIEF DESCRIPTION OF DRAWINGS

FIG. 1 It depicts a block diagram showing a configuration example of an image processing device of the first example embodiment.

FIG. 2 It depicts a block diagram showing a configuration example of a clustering unit.

FIG. 3 It depicts a block diagram showing a configuration example of a distance identification unit.

FIG. 4 It depicts a flowchart showing an example of an operation of an image processing device of the first example embodiment.

FIG. 5 It depicts a flowchart showing an example of an operation of a minimum spanning tree generation unit.

FIG. 6A It depicts an explanatory diagram for explaining clustering.

FIG. 6B It depicts an explanatory diagram for explaining clustering.

FIG. 7A It depicts an explanatory diagram for explaining clustering.

FIG. 7B It depicts an explanatory diagram for explaining clustering.

FIG. 7C It depicts an explanatory diagram for explaining clustering.

FIG. 8A It depicts an explanatory diagram for explaining clustering.

FIG. 8B It depicts an explanatory diagram for explaining clustering.

FIG. 9 It depicts an explanatory diagram for explaining clustering in an example embodiment.

FIG. 10 It depicts a block diagram showing a configuration example of an image processing device of the second example embodiment.

FIG. 11 It depicts a flowchart showing an example of an operation of an image processing device of the second example embodiment.

FIG. 12A It depicts an explanatory diagram for explaining an action of the pixel connection unit.

FIG. 12B It depicts an explanatory diagram for explaining an action of the pixel connection unit.

FIG. 12C It depicts an explanatory diagram for explaining an action of the pixel connection unit.

FIG. 12D It depicts an explanatory diagram for explaining an action of the pixel connection unit.

FIG. 13 It depicts a block diagram showing a configuration example of an image processing device of the third example embodiment.

FIG. 14 It depicts a flowchart showing an example of an operation of an image processing device of the third example embodiment.

FIG. 15 It depicts a block diagram showing a configuration example of an image processing device of the fourth example embodiment.

FIG. 16 It depicts a flowchart showing an example of an operation of an image processing device of the fourth example embodiment.

FIG. 17 It depicts a block diagram showing an example of a computer with a CPU.

FIG. 18 It depicts a block diagram showing the main part of an image processing unit.

### EXAMPLE EMBODIMENTS

Hereinafter, example embodiments of the present invention will be described with reference to the drawings.

### Example Embodiment 1

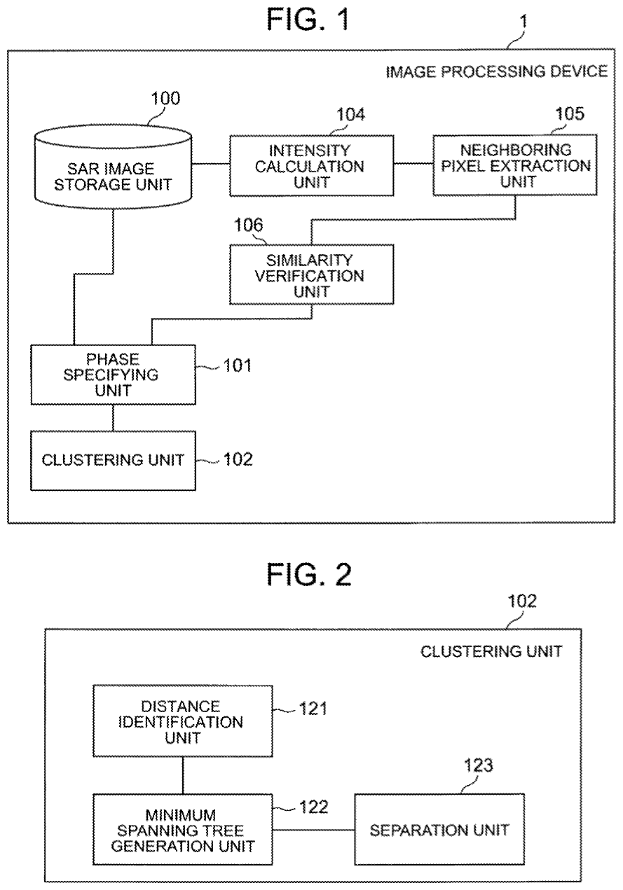

FIG. 1 is a block diagram showing an example configuration of an image processing device of the first example embodiment. The image processing device 1 shown in FIG. 1 includes a SAR image storage unit 100, a phase specifying unit 101, a clustering unit 102, an intensity calculation unit 104, a neighboring pixel extraction unit 105 and a similarity verification unit 106.

N pieces of SAR images are stored in the SAR image storage unit 100. The phase specifying unit 101 specifies a phase in each of a plurality of sample pixels (target pixels) based on the plurality of SAR images. The clustering unit 102 clusters the pixels based at least on the correlation of the phases of the sample pixels.

The intensity calculation unit 104 calculates intensity of the pixel. The neighboring pixel extraction unit 105 sets a window area including the sample pixel in the SAR image and extracts pixels in the window area. The similarity verification unit 106 identifies pixels (SHP) that are statistically homogeneous with the sample pixel based on the intensity of the sample pixel and the intensity of the extracted pixel.

FIG. 2 is a block diagram showing an example configuration of the clustering unit 102. In the example shown in FIG. 2, the clustering unit 102 includes a distance identification unit 121, a minimum spanning tree generation unit 122, and a separation unit 123.

The distance identification unit 121 calculates a distance indicating a relationship between the two sample pixels based on a distance between the two sample pixels (for example, Euclidean distance) and a correlation of phases of the two sample pixels. The minimum spanning tree generation unit 122 generates a minimum spanning tree for the sample pixels based on the distance calculated in the distance identification unit 121. The separation unit 123 separates the minimum spanning tree using a predetermined threshold value. A set of sample pixels belonging to the separated and generated tree becomes a cluster of sample pixels. In general, multiple clusters are generated. In the following, the case where the Euclidean distance is used as the distance between pixels in an image is used as an example, but the distance is not limited thereto.

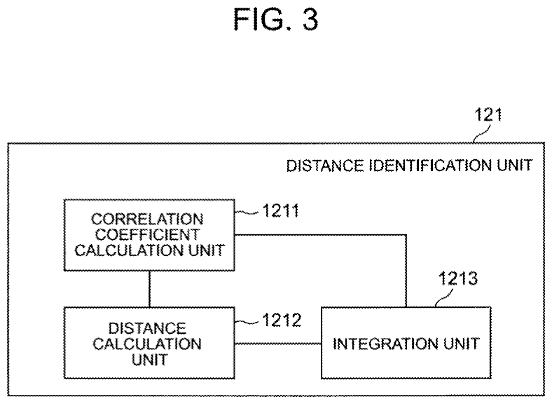

FIG. 3 is a block diagram showing an example configuration of the distance identification unit 121. The distance identification unit 121 includes a correlation coefficient calculation unit 1211, a distance calculation unit 1212, and an integration unit 1213.

The correlation coefficient calculation unit 1211 calculates a correlation coefficient for the phase specified by the phase specifying unit 101 with respect to the two sample pixels. The correlation coefficient calculation unit 1211 calculates a correlation coefficient for a phase (for example, each in a phase array) with respect to the two sample pixels.

The correlation coefficient calculation unit 1211, for example, performs the calculation on the correlation of the phase in the following manner. That is, when the phase specifying unit 101 specifies the phase as a complex number with an absolute value of 1, the correlation coefficient calculation unit 1211 may calculate the intensity of the correlation of the phase using the following formula (1). In the formula (1), each element of the phase array for the sample pixel a calculated by the phase specifying unit 101 is set to sₐₙ, and each element of the phase array for the sample pixel b is set to s_{bn}. N indicates a number of images. n indicates a number (No.) of images. The superscript line represents the complex conjugate.

$$\begin{matrix}[ Math . 1 ] & \\ \vert \frac{{\sum }_{n} {s}_{a n} {\overline{s}}_{b n}}{N} \vert & ( 1 )\end{matrix}$$

When the phase specifying unit 101 specifies the phase in the form of an angle, the correlation coefficient calculation unit 1211 may use Pearson product-moment correlation coefficient as the correlation coefficient of the phase.

The distance calculation unit 1212 calculates the Euclidean distance for two sample pixels. The distance calculation unit 1212 obtains the Euclidean distance in the SAR image by using the positional information such as the coordinates of the two sample pixels, using a known method or the like.

The integration unit 1213 determines a relationship between the two sample pixels based on the correlation coefficient for the two sample pixels calculated by the correlation coefficient calculation unit 1211 and the Euclidean distance for the two sample pixels calculated by the distance calculation unit 1212. The relationship is expressed as a distance. The distance between the two sample pixels is a small value when the correlation between the two sample pixels is strong. However, the correlation coefficient generally becomes a large value when the correlation is strong. Therefore, the integration unit 1213 may be provided with a conversion unit. The conversion unit converts the correlation coefficient, which is a large value when the correlation is strong, to be a small value when the correlation is strong.

The distance can be an indicator of the degree of relationship between the two sample pixels, and the integration unit 1213 may obtain the distance by a process different from the process described above.

In addition, the integration unit 1213 may obtain the distance by assigning a weight to at least one of the correlation coefficient and the Euclidean distance, for example. In the case where the weight is used, a distance is obtained that strongly reflects the one to be emphasized among the correlation coefficient and the Euclidean distance. For example, if a weight of 0 is assigned to the Euclidean distance, a distance based only on the correlation coefficient of the phase is calculated.

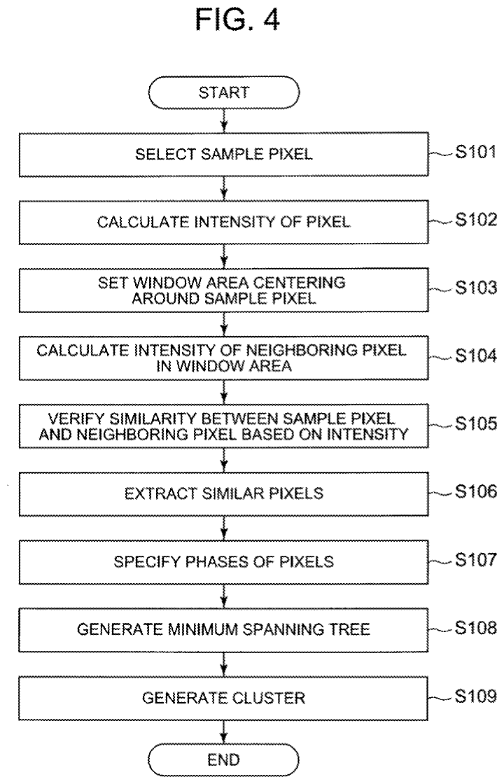

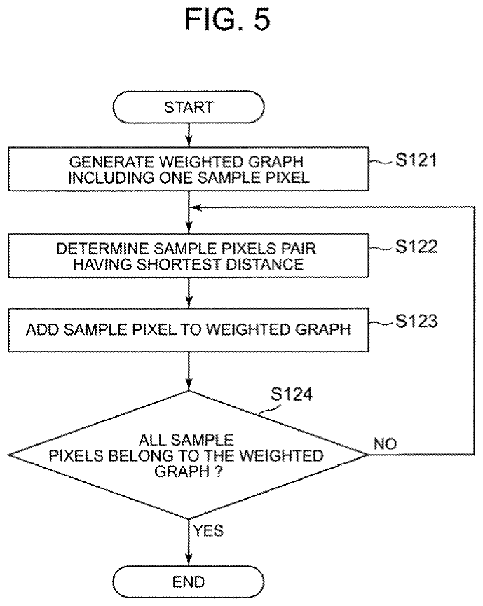

Next, the operation of the image processing device 1 will be described with reference to the flowcharts of FIGS. 4 and 5. FIG. 4 is a flowchart showing the operation of the image processing device 1.

The intensity calculation unit 104 selects a sample pixel from the SAR image (step S101), and calculates intensity (which may be an amplitude value) of the sample pixel (Step S102). The sample pixels are PS point pixels, for example, but they may be all pixels in the SAR image.

The neighboring pixel extraction unit 105 sets a window area in the SAR image that includes the sample pixel, such as a window area in which the closest pixel from the centroid is the sample pixel (Step S103). Then, the neighboring pixel extractor 105 extracts pixels in the window area as neighboring pixels. The size of the window area is arbitrary, but as an example, 10×10 pixels in height and width or 100×100 pixels are used as the size of the window area. The size of the window area is not limited to an even number. In addition, the shape of the window area is not limited to a square. The shape of the window area may be a rectangle (11×21 pixels, as an example) or a non-rectangle such as an ellipse. The shape of the window area may be different for each sample pixel, depending on the topography or other factors. The window area may be composed of a plurality of discrete pixels (for example, the window area is formed by a plurality of pixels selected every other pixel), rather than a plurality of consecutive pixels. For example, the window area is formed by a plurality of pixels selected every other pixel.

The similarity verification unit 106 calculates intensity of the neighboring pixels (step S104). The similarity verification unit 106 verifies, for example, whether the intensity of the sample pixel and the intensity of the neighboring pixel are generated by the same probability distribution function (step S105). Then, the similarity verification unit 106 makes the neighboring pixel generated by the same probability distribution function as the sample pixel a statistically homogeneous pixel with the sample pixel. The similarity verification unit 106 outputs the plurality of pixels (including the sample pixel) that are statistically homogeneous with the sample pixel to the phase specifying unit 101.

The phase specifying unit 101 specifies a phase in each of the sample pixels (step S107). The phase specifying unit 101 specifies the phase, for example, by making a phase array. Specifically, the phase specifying unit 101 makes, for each pixel, an array in which the phase at that pixel of each of the plurality of SAR images is an element, i.e., a phase array.

The phase specifying unit 101 may determine a change in phase (phase difference) between the reference SAR image and other SAR images, as an example of the phase of the pixel. In this case, the reference SAR image is predetermined among a plurality of SAR images taken of the same area. Then, the phase specifying unit 101 uses the phase difference as an element of the phase array. As another example, the phase specifying unit 101 may make a phase array by arranging the phases of the relevant pixels in the plurality of SAR images in chronological order or the like, without defining a reference SAR image.

The phase is expressed in the form of a complex number normalized so that the absolute value is 1, for example.

In this example embodiment, in the clustering unit 102, the minimum spanning tree generation unit 122 generates a minimum spanning tree for clustering the pixels (step S108). The minimum spanning tree is a tree structure in which all the pixels selected in the process of step S106 are connected by edges such that the sum of the distances calculated by the distance identification unit 121 is minimized, so that no closed paths are configured. In this example embodiment, each of the edges in the minimum spanning tree is weighted by the distance between the two pixels connected to the edge.

FIG. 5 is a flowchart showing the operation of the minimum whole area tree generation unit 122.

In the example shown in FIG. 5, the minimum spanning tree generation unit 122 generates the minimum spanning tree by the prim method for clustering, but the minimum spanning tree may also be generated by the Kruskal's algorithm.

The clustering unit 102 may also use other clustering methods, as long as the correlation of the phases of at least the pixels is used. One example of another clustering methods is to classify the pixels into one of the clusters based on the distance between the pixels and the centroid of the respective cluster. Another example of a clustering method is to classify a pixel into one of the clusters based on the similarity between the pixels calculated by a function called a kernel. As a method using a kernel, a graph may be generated by calculating the similarity between pixels and dividing the edges such that the similarity is minimized, or a method may be used to maximize the similarity between each pixel and a centroid defined based on the similarity.

In the example shown in FIG. 5, the minimum spanning tree generation unit 122 randomly selects one of the pixels to generate a weighted graph (step S121). Next, the minimum spanning tree generation unit 122 determines a distance between any pixel belonging to the weighted graph and a plurality of pixels not belonging to the weighted graph. The minimum spanning tree generation unit 122 decides a pair of two pixels that have the shortest distance to the pixel belonging to the weighted graph (step S122). The distance is calculated by the distance identification unit 121, which includes the correlation coefficient calculation unit 1211, the distance calculation unit 1212, and the integration unit 1213, as described above.

The minimum spanning tree generation unit 122 adds a pixel in the determined pair that do not belong to the weighted graph to the weighted graph (step S123). The minimum spanning tree generation unit 122 adds an edge connecting two pixels included in the pair to the weighted graph.

Next, the minimum spanning tree generation unit 122 determines whether all the pixels belong to the weighted graph (step S124). When all the pixels belong to the weighted graph, the process is terminated. When there are pixels that do not belong to the weighted graph, the process returns to step S122.

The separation unit 123 clusters the pixels (step S104). That is, the separation unit 123 separates the minimum spanning tree using a predetermined threshold value. A set of pixels in each of the graphs generated by separating the weighted graphs becomes a cluster. The threshold value is determined based on an average value or a standard deviation of distances between two pixels connected by an edge in the minimum global tree. As an example, the separation unit 123 determines the clusters so that the distance between the pixels belonging to the clusters is less than or equal to the threshold value. The separation unit 123 may determine the clusters so that the standard deviation of the distances between the pixels belonging to the clusters is less than or equal to the threshold value, for example.

When generating clusters, the separation unit 123 may set a limit on the size (number of pixels belonging to) of each cluster.

As described above, the image processing device 1 of this example embodiment clusters the pixels based on the correlation of at least the phases of the pixels. Thus, clusters are generated that contain pixels with aligned an average of the phases and a variance of the phases.

Furthermore, in this example embodiment, since the image processing device 1 increases the number of pixels to be clustered based on the identity (being statistically homogeneous) of the pixels based on the intensity, and performs clustering based on the phase, possibility of generating clusters more accurately increases. The identity refers to whether or not the image is statistically homogeneous. In other words, the identity indicates that the pixels are similar.

In addition, when the image processing device 1 of this example embodiment is used, the number of pixels subject to clustering can be increased, so that when a SAR image is used, the object of observation such as a ground surface or a structure can be more easily and accurately associated with the corresponding part in the SAR image. This is also true for the following example embodiments.

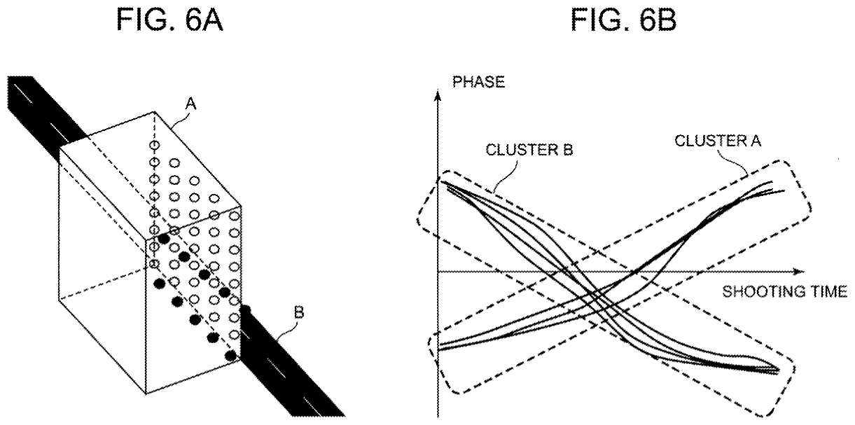

FIGS. 6A and 6B are explanatory diagrams for explaining clustering in this example embodiment. In the example shown in FIGS. 6A and 6B, a building A and a road B are included in the SAR image. In FIG. 6A, the circles indicate sample pixels. The white circles indicate pixels associated with the wall of the building A. The black filled circles indicate pixels associated with the road B.

For the multiple pixels associated with the wall of the building A, the distance between the phase of one pixel and the phase of another pixel is short. Therefore, they are classified into a cluster A, as shown in FIG. 6B. With respect to the plurality of pixels associated with the road B, the distance between the phase of each pixel and the phase of other pixels is short. Therefore, they are classified into a cluster B, as shown in FIG. 6B.

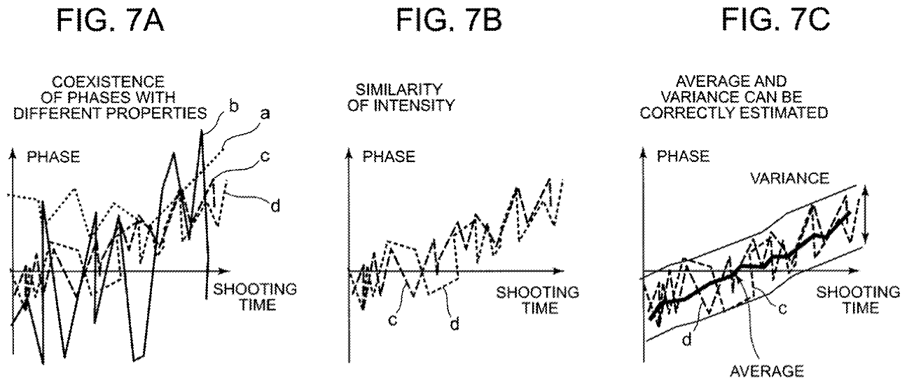

The effects of this example embodiment will be explained in more detail with reference to explanatory diagrams of FIGS. 7A, 7B, 7C, 8A, 8B and 9.

Suppose that there are pixels a, b, c, and d whose phases vary as shown in FIG. 7A. Further, suppose that similar pixels c and d are selected based on intensity as described in patent literature 2 (refer to FIG. 7B). As shown in FIG. 7C, if the average variations of the phase of each of the pixels c and d are comparable and the variances of the phase of the pixels c and d are small, the accuracy of the calculated coherence matrix is not low.

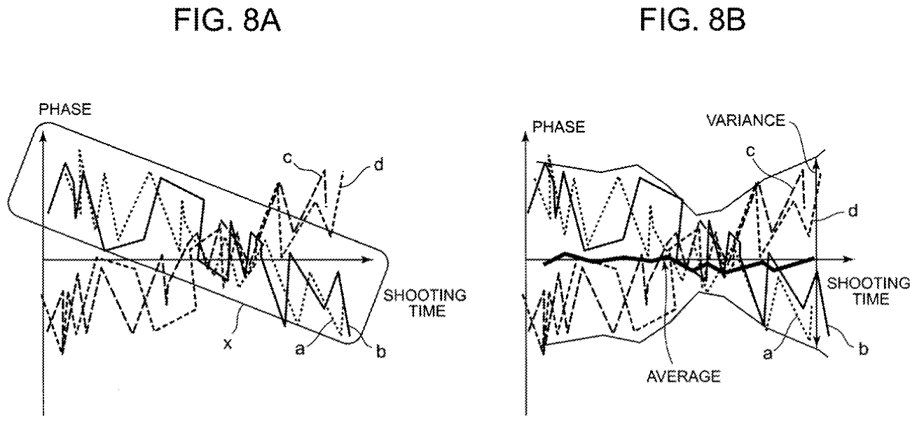

As shown in FIG. 8A, suppose that among the pixels a, b, c, and d that are determined to be similar based on intensity, there are pixels that increase the variance of the phases (refer to the other pixels out of the frame X in FIG. 8A). In such a case, when the statistical property of the phase are not considered, pixels with different statistical properties are included in the pixels to be clustered, as shown in FIG. 8B.

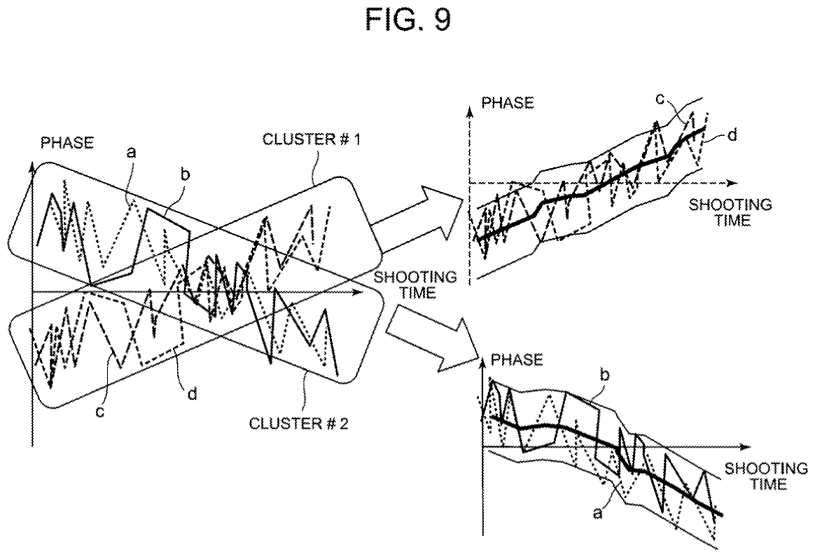

FIG. 9 is an explanatory diagram for explaining a result of the coherence matrix calculation by an image processing method implemented in the image processing device 1 of this example embodiment.

In this example embodiment, as shown in FIG. 9, pixels that have similar statistical properties of phase (for example, variance and average) belong to one cluster (cluster #1 and cluster #2, respectively).

### Example Embodiment 2

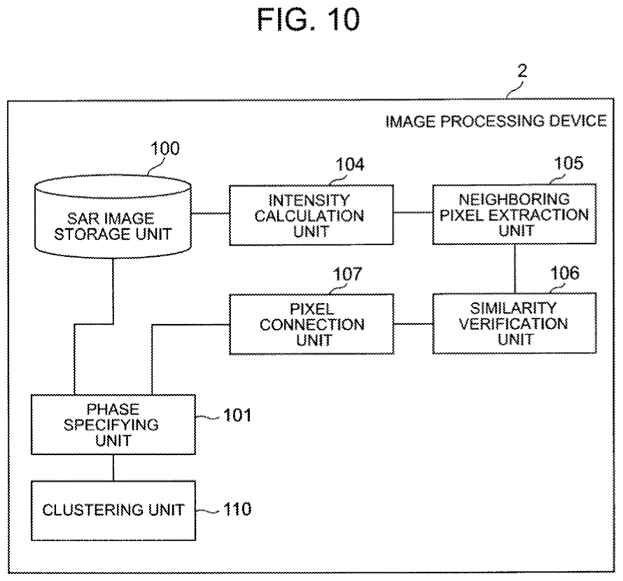

FIG. 10 is a block diagram showing an example configuration of an image processing device of the second example embodiment. The configuration of the image processing device 2 shown in FIG. 10 is a configuration in which a pixel connection unit 107 is added to the image processing device 1 of the first example embodiment, and a clustering unit 102 is replaced by a clustering unit 110.

The pixel connection unit 107 connects the pixels that have identity based on intensity to graph them. As described below, the clustering unit 110 performs clustering by a process different from the process of the clustering unit 102 in the first example embodiment.

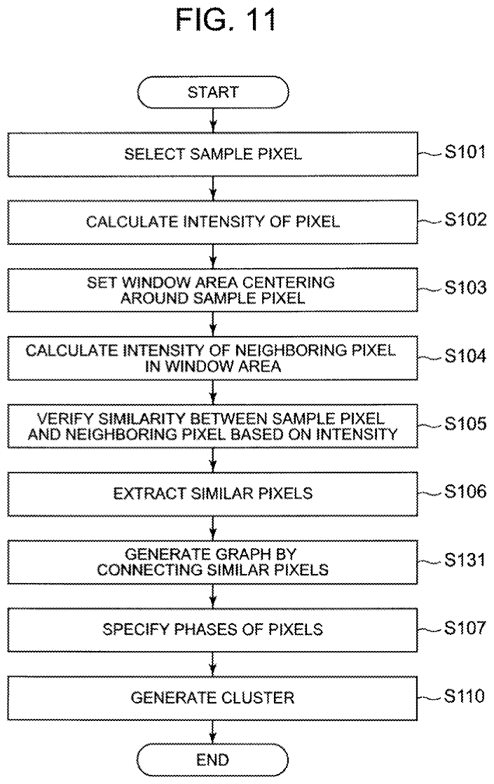

FIG. 11 is a flowchart showing the operation of the image processing device 2. As shown in FIG. 11, the image processing device 2 executes the processing of step S131 in addition to the processing of the image processing device 1 of the first example embodiment (the processing shown in FIG. 4). In addition, the image processing device 2 executes the process of step S110 in place of the processes of steps S108 and S109 shown in FIG. 4. The other processing is the same as the processing performed by the image processing device 1 of the first example embodiment.

In step S131, the pixel connecting unit 107 generates a graph by connecting pixels that are determined to be identical by the similarity verification unit 106. In step S110, the clustering unit 110 generates clusters by cutting edges between pixels whose phase correlation is less than a predetermined threshold value. The threshold value is set according to the size of the desired cluster and the like.

In this example embodiment, as in the first example embodiment, since the image processing unit 2 increases the number of pixels to be clustered based on the identity of the pixels based on the intensity, and performs clustering based on the phase, possibility of generating clusters more accurately increases.

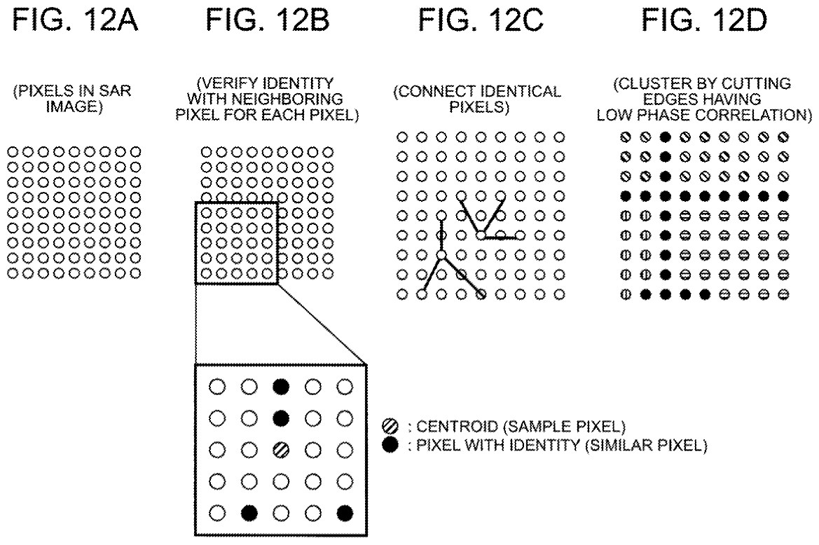

FIGS. 12A to 12D are explanatory diagrams for explaining the action of the pixel connection 107.

The neighboring pixel extraction unit 105 and the similarity verification unit 106 verify the identity based on the intensity of the sample image in the SAR image as illustrated in FIG. 12A (refer to FIG. 12B). The pixel connection unit 107 connects pixels that are determined to be identical (similar) to each other to graph the pixels in the SAR image (refer to FIG. 12C). In FIG. 12C, the connection is represented schematically and is not consistent with the state shown in FIG. 12B.

The clustering unit 110 generates clusters by cutting edges between pixels with weak phase correlation (refer to FIG. 12D). Four clusters are illustrated in FIG. 12D.

### Example Embodiment 3

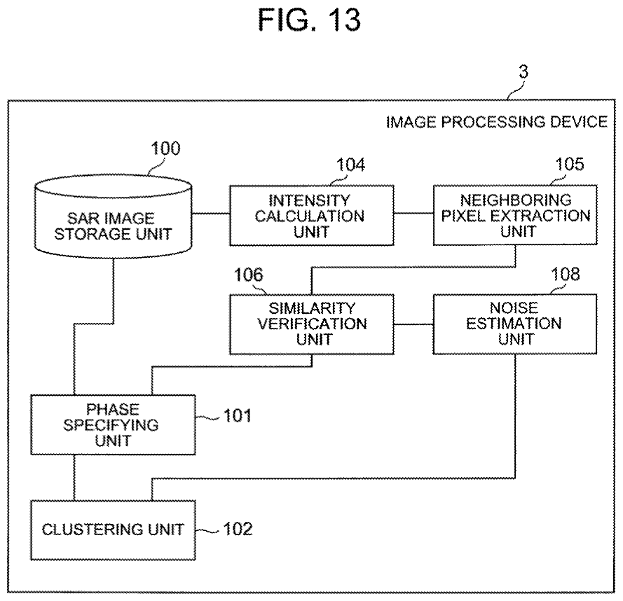

FIG. 13 is a block diagram showing an example configuration of an image processing device of the third example embodiment. The configuration of the image processing device 3 shown in FIG. 13 is a configuration in which a noise estimation unit 108 is added to the image processing device 1 of the first example embodiment.

The noise estimation unit 108 estimates statistical properties related to noise in the surrounding pixels. As noise in a SAR image, for example, there is noise caused by fluctuations in intensity among pixels. In that case, the variance of the intensity of the pixels is reflected in the noise.

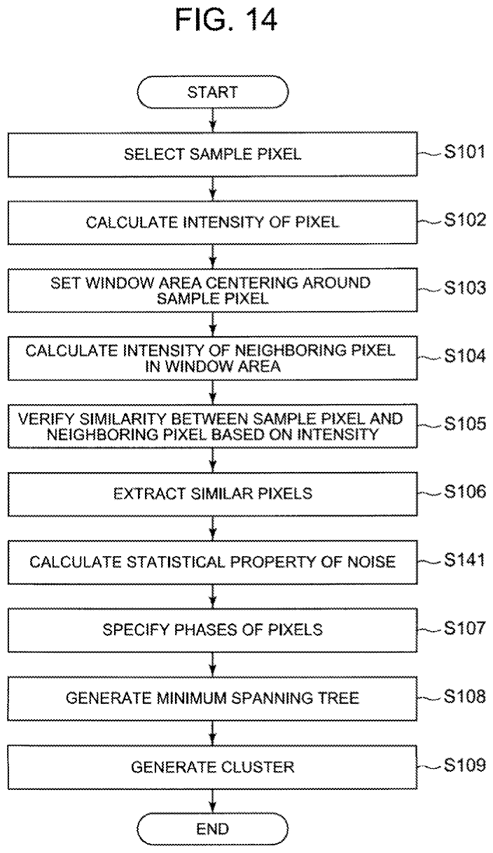

FIG. 14 is a flowchart showing the operation of the image processing device 4. As shown in FIG. 14, the image processing device 3 executes the processing of step S141 in addition to the processing of the image processing device 1 of the first example embodiment (refer to FIG. 4). Other processing is the same as the processing performed by the image processing device 1 of the first example embodiment. However, as described below, the clustering unit 102 refers to the processing result of the noise estimation unit 108 when clustering the pixels.

In step S141, the noise estimation unit 108 calculates, for example, the variance of the intensity of each pixel selected according to the result of the verification by the similarity verification unit 106. The noise estimation unit 108 outputs the calculation result to the clustering unit 102.

In the clustering process, the clustering unit 102 may, for example, relax the criteria for classification into the same cluster when the variance of the intensity regarding the pixels to be clustered is large. As an example, the clustering unit 102 reduces the threshold for classifying into the same cluster. In addition, for pixels with small intensity variance (i.e., small noise), the criteria for being classified into the same cluster can be increased. By executing such processing by the clustering unit 102, a plurality of pixels having a large phase correlation are classified into the same cluster.

In this example embodiment, the variance of the pixel intensity is used as an example as a statistical property on noise, but the statistical property on noise is not limited to the variance of the pixel intensity. Other statistical properties such as an average of the pixel intensity may be used as the statistical property on noise.

In addition, although this example embodiment uses the example of the clustering threshold being changed based on statistical property on noise, statistical property on noise may be used for other purposes. For example, the statistical property on noise can be used to change the degree (measure) of correlation to be determined to belong to one cluster when pixels are clustered based on the phase correlation of the pixels.

When the image processing device 3 of this example embodiment is used, the processing result of the noise estimation unit 108 may be used to obtain a cluster configuration (for example, a cluster configuration whose size is a predetermined size or in which statistical property regarding phases of pixels are aligned to a predetermined degree) intended by a designer or the like. For example, the parameters (for example, threshold) for clustering may be modified based on statistical properties on the noise in order to obtain the intended cluster configuration.

### Example Embodiment 4

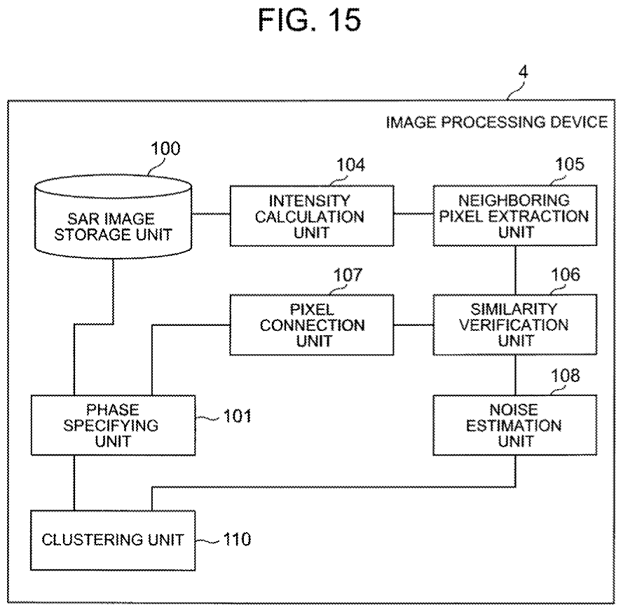

FIG. 15 is a block diagram showing an example configuration of an image processing device of the fourth example embodiment. The configuration of the image processing device 4 shown in FIG. 15 is a configuration in which a noise estimation unit 108 is added to the image processing device 2 of the second example embodiment shown in FIG. 10.

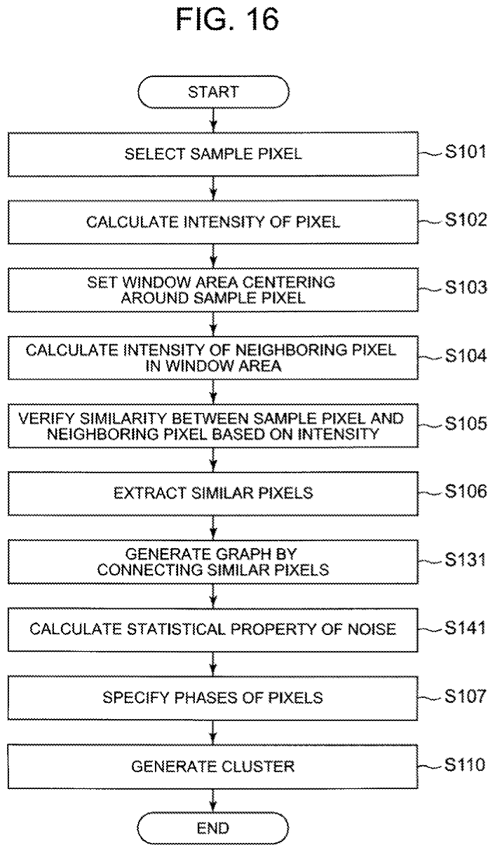

FIG. 16 is a flowchart showing the operation of the image processing device 4. As shown in FIG. 16, the image processing device 4 executes the processing of step S141 in addition to the processing of the image processing device 2 of the second example embodiment (refer to FIG. 11). The other processing is the same as the processing performed by the image processing device 3 of the third example embodiment shown in FIG. 13. However, the clustering unit 110 refers to the processing result of the noise estimation unit 108 when clustering the pixels. The clustering unit 110 refers to the processing result of the noise estimation unit 108 in a manner similar to the manner in which the clustering unit 102 refers to the processing result of the noise estimation unit 108 in the third example embodiment.

The processing of step S141 is the same as the processing performed by the noise estimation unit 108 in the third example embodiment, but the processing of step S131 by the pixel connection unit 107 and the processing of step S141 by the noise estimation unit 108 can be performed simultaneously.

In this example embodiment, as in the case of the second example embodiment, possibility of generating clusters more accurately increases, and as in the case of the third example embodiment, a cluster configuration (for example, a cluster configuration whose size is a predetermined size or in which statistical property regarding phases of pixels are aligned to a predetermined degree) intended by a designer or the like can be obtained.

Each component in each of the above example embodiments may be configured with a single piece of hardware, but can also be configured with a single piece of software. Alternatively, the components may be configured with a plurality of pieces of hardware or a plurality of pieces of software. Further, part of the components may be configured with hardware and the other part with software.

The functions (processes) in the above example embodiments may be realized by a computer having a processor such as a central processing unit (CPU), a memory, etc. For example, a program for performing the method (processing) in the above example embodiments may be stored in a storage device (storage medium), and the functions may be realized with the CPU executing the program stored in the storage device.

FIG. 17 is a block diagram showing an example of a computer having a CPU. The computer is implemented in an image processing device. The CPU 1000 executes processing in accordance with a program stored in a storage device 1001 to realize the functions in the above example embodiments. That is to say, the functions of the phase specifying unit 101, the clustering units 102, 110, the intensity calculation unit 104, the neighboring pixel extraction unit 105, the similarity verification unit 106, the pixel connection unit 107, and the noise estimation unit 108 in the image processing devices shown in FIGS. 1, 10, 13, 15.

The storage device 1001 is, for example, a non-transitory computer readable media. The non-transitory computer readable medium is one of various types of tangible storage media. Specific examples of the non-transitory computer readable media include a magnetic storage medium (for example, flexible disk, magnetic tape, hard disk), a magneto-optical storage medium (for example, magneto-optical disc), a compact disc-read only memory (CD-ROM), a compact disc-recordable (CD-R), a compact disc-rewritable (CD-R/W), and a semiconductor memory (for example, a mask ROM, a programmable ROM (PROM), an erasable PROM (EPROM), a flash ROM).

The program may be stored in various types of transitory computer readable media. The transitory computer readable medium is supplied with the program through, for example, a wired or wireless communication channel, or, through electric signals, optical signals, or electromagnetic waves.

The memory 1002 is a storage means implemented by a RAM (Random Access Memory), for example, and temporarily stores data when the CPU 1000 executes processing. It can be assumed that a program held in the storage device 1001 or a temporary computer readable medium is transferred to the memory 1002 and the CPU 1000 executes processing based on the program in the memory 1002.

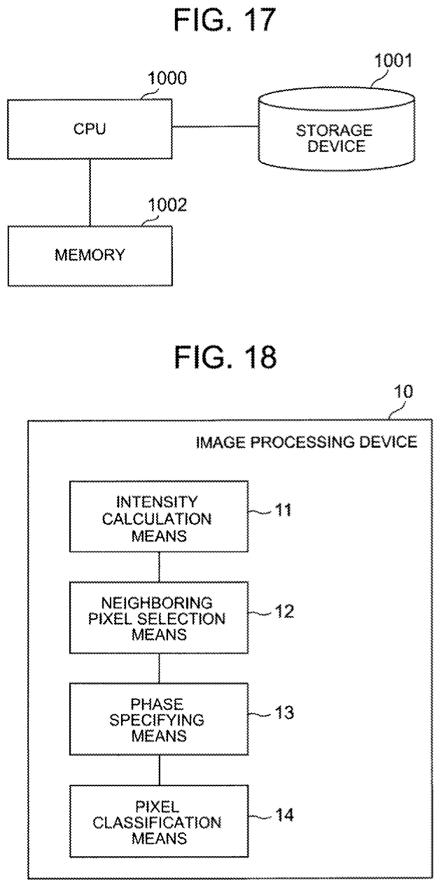

FIG. 18 is a block diagram showing the main part of the image processing device. The image processing device 10 shown in FIG. 18 comprises intensity calculation means 11 (in the example embodiments, realized by the intensity calculating unit 104) for calculating intensity of the sample pixel, neighboring pixel selection means 12 (in the example embodiments, realized by the neighboring pixel extraction unit 105 and the similarity verification unit 106) for selecting neighboring pixels that have a similar statistical property of intensity to the sample pixel, based on the intensity of the sample pixel, phase specifying means 13 (in the example embodiments, realized by the phase specifying unit 101) for specifying phases of the neighboring pixels, and pixel classification means 14 (in the example embodiments, realized by the clustering unit 102, 110) for classifying the neighboring pixels based on correlation of the phases of the neighboring pixels.

A part of or all of the above example embodiments may also be described as, but not limited to, the following supplementary notes.

(Supplementary note 1) An image processing device comprising:
intensity calculation means for calculating intensity of the sample pixel,
neighboring pixel selection means for selecting neighboring pixels that have a similar statistical property of intensity to the sample pixel, based on the intensity of the sample pixel,
phase specifying means for specifying phases of the neighboring pixels, and
pixel classification means for classifying the neighboring pixels based on correlation of the phases of the neighboring pixels.

(Supplementary note 2) The image processing device according to claim 1, wherein
the pixel classifying means generates a plurality of clusters by classifying the neighboring pixels.

(Supplementary note 3) The image processing device according to Supplementary note 2, wherein
the pixel classifying means connects the neighboring pixels having the similar statistical property to graph them, and
the pixel classifying means generates the clusters by cutting edges between the pixels whose phase correlation is less than or equal to a predetermined threshold in a graph generated by the pixel connecting means.

(Supplementary note 4) The image processing device according to any one of Supplementary notes 1 to 3, further comprising
noise estimation means for estimating a statistical property of noise of the neighboring pixel,
wherein
the pixel classifying means classifies the neighboring pixels with reference to the statistical property of the noise.

(Supplementary note 5) An image processing method comprising:
calculating intensity of the sample pixel,
selecting neighboring pixels that have a similar statistical property of intensity to the sample pixel, based on the intensity of the sample pixel,
specifying phases of the neighboring pixels, and
classifying the neighboring pixels based on correlation of the phases of the neighboring pixels.

(Supplementary note 6) The image processing method according to Supplementary note 5, further comprising
generating a plurality of clusters by classifying the neighboring pixels.

(Supplementary note 7) The image processing method according to Supplementary note 6, further comprising
connecting the neighboring pixels having the similar statistical property to graph them, and
generating clusters by cutting edges between the pixels whose phase correlation is less than or equal to a predetermined threshold in a generated graph.

(Supplementary note 8) The image processing method according to any one of Supplementary notes 5 to 7, further comprising
estimating a statistical property of noise of the neighboring pixel, and
classifying the neighboring pixels with reference to the statistical property of the noise.

(Supplementary note 9) An image processing program causing a computer to execute:
a process of calculating intensity of the sample pixel,
a process of selecting neighboring pixels that have a similar statistical property of intensity to the sample pixel, based on the intensity of the sample pixel,
a process of specifying phases of the neighboring pixels, and
a process of classifying the neighboring pixels based on correlation of the phases of the neighboring pixels.

(Supplementary note 10) The image processing program according to Supplementary note 9, causing the computer to further execute
a process of generating a plurality of clusters by classifying the neighboring pixels.

(Supplementary note 11) The image processing program according to Supplementary note 10, causing the computer to further execute
a process of connecting the neighboring pixels having the similar statistical property to graph them, and
a process of generating clusters by cutting edges between the pixels whose phase correlation is less than or equal to a predetermined threshold in a generated graph.

(Supplementary note 12) The image processing program according to any one of Supplementary notes 9 to 11, causing the computer to further execute
a process of estimating a statistical property of noise of the neighboring pixel, and
a process of classifying the neighboring pixels with reference to the statistical property of the noise.

Although the invention of the present application has been described above with reference to example embodiments, the present invention is not limited to the above example embodiments. Various changes can be made to the configuration and details of the present invention that can be understood by those skilled in the art within the scope of the present invention.

### REFERENCE SIGNS LIST

1, 2, 3, 4, 10 Image processing device
11 Intensity calculation means
12 Neighboring pixel selection means
13 Phase specifying means
14 Pixel classification means
100 SAR image storage unit
101 Phase specifying unit
102, 110 Clustering unit
104 Intensity calculation unit
105 Neighboring pixel extraction unit
106 Similarity verification unit
107 Pixel connection unit
108 Noise estimation Unit
1000 CPU
1001 Storage device
1002 Memory

What is claimed is:

1. An image processing device comprising:
an intensity calculation unit which calculates intensity of the sample pixel,
a neighboring pixel selection unit which selects neighboring pixels that have a similar statistical property of intensity to the sample pixel, based on the intensity of the sample pixel,
a phase specifying unit which specifies phases of the neighboring pixels, and
a pixel classification unit which classifies the neighboring pixels based on correlation of the phases of the neighboring pixels.

2. The image processing device according to claim 1, wherein
the pixel classifying unit generates a plurality of clusters by classifying the neighboring pixels.

3. The image processing device according to claim 2, wherein
the pixel classifying unit connects the neighboring pixels having the similar statistical property to graph them, and
the pixel classifying unit generates the clusters by cutting edges between the pixels whose phase correlation is less than or equal to a predetermined threshold in a graph generated by the pixel connecting unit.

4. The image processing device according to claim 1, further comprising
a noise estimation unit which estimates a statistical property of noise of the neighboring pixel,
wherein
the pixel classifying unit classifies the neighboring pixels with reference to the statistical property of the noise.

5. An image processing method comprising:
calculating intensity of the sample pixel,
selecting neighboring pixels that have a similar statistical property of intensity to the sample pixel, based on the intensity of the sample pixel,
specifying phases of the neighboring pixels, and
classifying the neighboring pixels based on correlation of the phases of the neighboring pixels.

6. The image processing method according to claim 5, further comprising
generating a plurality of clusters by classifying the neighboring pixels.

7. The image processing method according to claim 6, further comprising
connecting the neighboring pixels having the similar statistical property to graph them, and
generating clusters by cutting edges between the pixels whose phase correlation is less than or equal to a predetermined threshold in a generated graph.

8. The image processing method according to claim 5, further comprising
estimating a statistical property of noise of the neighboring pixel, and
classifying the neighboring pixels with reference to the statistical property of the noise.

9. A non-transitory computer readable recording medium storing an image processing program which, when executed by a processor, performs:
calculating intensity of the sample pixel,
selecting neighboring pixels that have a similar statistical property of intensity to the sample pixel, based on the intensity of the sample pixel,
specifying phases of the neighboring pixels, and
classifying the neighboring pixels based on correlation of the phases of the neighboring pixels.

10. The computer readable recording medium according to claim 9, wherein when executed by the processor, the program further performs
generating a plurality of clusters by classifying the neighboring pixels.

11. The computer readable recording medium according to claim 10, wherein when executed by the processor, the program further performs
connecting the neighboring pixels having the similar statistical property to graph them, and
generating clusters by cutting edges between the pixels whose phase correlation is less than or equal to a predetermined threshold in a generated graph.

12. The computer readable recording medium according to claim 9, wherein when executed by the processor, the program further performs
estimating a statistical property of noise of the neighboring pixel, and
classifying the neighboring pixels with reference to the statistical property of the noise.

13. The image processing device according to claim 2, further comprising
a noise estimation unit which estimates a statistical property of noise of the neighboring pixel,
wherein
the pixel classifying unit classifies the neighboring pixels with reference to the statistical property of the noise.

14. The image processing device according to claim 3, further comprising
a noise estimation unit which estimates a statistical property of noise of the neighboring pixel,
wherein
the pixel classifying unit classifies the neighboring pixels with reference to the statistical property of the noise.

15. The image processing method according to claim 6, further comprising
estimating a statistical property of noise of the neighboring pixel, and
classifying the neighboring pixels with reference to the statistical property of the noise.

16. The image processing method according to claim 7, further comprising
estimating a statistical property of noise of the neighboring pixel, and
classifying the neighboring pixels with reference to the statistical property of the noise.
